(19) United States
(12) Patent Application Publication
(10) Pub. No.: US 2026/0022040 A1
(43) Pub. Date: Jan. 22, 2026

(54) Performance of Sulfated Coagulants by Photoactivation Prior to Dosing

(71) Applicant: USALCO, LLC, Baltimore, MD (US)

(72) Inventors: Steven Patrick Cronin, Pikesville, MD (US); James M. Dulko, Annapolis, MD (US)

(21) Appl. No.: 19/271,170

(22) Filed: Jul. 16, 2025

Related U.S. Application Data
(60) Provisional application No. 63/672,453, filed on Jul. 17, 2024.

(51) Int. Cl. C02F 1/52; C02F 103/00

(52) U.S. Cl. CPC C02F 1/5209; C02F 1/5245; C02F 1/5281; C02F 2103/007

(57) ABSTRACT

A water treatment system includes a water stream configured to provide raw water to be treated, a coagulant source configured to hold one or more sulfated coagulants, and one or more photoreactors configured to activate the one or more sulfated coagulants to produce an activated sulfated coagulant and configured to add the activated sulfated coagulant to the water stream within a determined period. Methods of water treatment are also disclosed.

### CROSS-REFERENCE TO RELATED APPLICATIONS

This application claims the benefit of U.S. Provisional Patent Application No. 63/672,453, filed Jul. 17, 2024, the disclosure of which is incorporated herein by reference in its entirety.

### TECHNICAL FIELD

The present invention relates to sulfated coagulants, such as aluminum sulfate and sulfated polyaluminum chlorides, and more particularly to systems and methods that improve the performance of sulfated coagulants in water treatment systems.

### BACKGROUND ART

Most municipal water treatment coagulation and flocculation processes utilize metal salts as the preferred coagulant. Improvements have been made with the development of poly aluminum chloride, and poly aluminum sulfate. These products are expensive to make and are pricier than the commodity salts. The metal salts, aluminum sulfate, ferric chloride and ferric sulfate are still widely used although they suffer from efficiency problems, take longer to form flocs, generate large amount of water plant residuals and significant pH depression among other problems associated with their use.

Flocculants operate under the premise that when introduced in the rapid mix phase, the pH shifts in such a manner that these substances can hydrolyze rapidly, in an uncontrolled manner. During hydrolysis, Al(OH)ₓ(Y)₃₋ₓ is formed, where Y is some organic species that is trapped within the water space, and x denotes the stoichiometry of the hydroxy species. Upon formation of these substances, they begin to polymerize and become insoluble in water, and thus generate “floc”, which causes impurities to fall out of the solution with this floc. These reaction conditions tend to be pH and temperature dependent. Polyaluminum chloride (PAC) is different from the other coagulants due to the fact that these substances are “prehydrolyzed” in such a manner that flocculation occurs over a wider range of pH and temperature, resulting in the need to dose a significantly smaller amount.

The allure of being able to treat hard to deal water with impurities, such as polyfluoroalkyl substances (PFAS), has attracted a large amount of interest in recent years. Tenorio et al. showed that by adding sodium sulfite to a solution containing PFAS can result in significant destruction within the solution. Liu et al. showed that addition of sodium iodide to this UV/sulfite solution results in reductive defluorination of the PFAS compounds. This work showed that difficult to remove PFAS compounds could be destroyed by up to 50% of the initial amount. However, a review by Fennell et al. explained that while radicals are great at removing PFAS, it should be noted that other radical scavengers likely will react first over PFAS. One of those scavengers that was often listed as “problematic” for radicals is total organic carbons (TOCs).

Sulfate radicals are important in atmospheric chemistry and have been shown to be able to be produced from higher energy light sources, such as 189 nm and 254 nm. However, sulfate radicals have a very short half-life of 30-40 μs. Aluminum may stabilize radicals long enough for crystals to be generated. One such compound is cyclic (alkyl)(amino) carbene (cAAC), which when reacted with aluminum and a strong reductant, KC₈ is used. Aluminum complexes have been used to stabilize redox active ligands. Therefore, there is a need to improve the performance of sulfated coagulants in water treatment systems.

### SUMMARY OF EMBODIMENTS

In accordance with one embodiment of the present invention, a water treatment system includes a water stream configured to provide raw water to be treated, a coagulant source configured to hold one or more sulfated coagulants, and one or more photoreactors configured to activate the one or more sulfated coagulants to produce an activated sulfated coagulant and configured to add the activated sulfated coagulant to the water stream within a determined period.

In accordance with another embodiment of the present invention, a method of water treatment includes providing one or more sulfated coagulants, activating the one or more sulfated coagulants using a photochemical process to produce an activated sulfated coagulant, and adding the activated sulfated coagulant into raw water within a determined period.

In related embodiments, the one or more sulfated coagulants may include aluminum sulfate, ferric sulfate, polyaluminum chlorosulfate, polyaluminum sulfate, and/or ferrous sulfate. The one or more photoreactors may include a coagulant controller configured to add the activated sulfated coagulant to the water stream within about 3 seconds to about 5 seconds from activating the one or more sulfated coagulants. The one or more photoreactors may be configured to activate the one or more sulfated coagulants using one or more light sources having wavelengths ranging between about 185 nm to about 600 nm, preferably ranging between about 185 nm to about 300 nm, and more preferably ranging between about 185 nm to about 254 nm. The one or more light sources may be configured to irradiate the one or more sulfated coagulants for about 3 seconds to about 150 minutes. Alternatively, or in addition, one or more of the light sources may be configured to continuously irradiate the one or more sulfated coagulants. The one or more light sources may include a mercury halogen lamp, an LED light, a fluorescent lamp, and/or a neon lamp. For example, the one or more light sources may include a mercury halogen lamp and may be configured to irradiate the one or more sulfated coagulants for about 3 seconds to about 15 minutes. Alternatively, or in addition, the one or more light sources may include an LED light and may be configured to irradiate the one or more sulfated coagulants for about 60 minutes to about 150 minutes. The water treatment system may further include a gas source configured to purge the one or more sulfated coagulants with an inert gas before the one or more photoreactors are configured to activate the one or more sulfated coagulants.

### BRIEF DESCRIPTION OF DRAWINGS

The foregoing features of embodiments will be more readily understood by reference to the following detail description, taken with reference to the accompanying drawings in which:

FIG. 1 shows a water treatment system according to embodiments of the present invention.

FIG. 2 shows the results of the reaction of alum with jar test water under the conditions of No irradiation (control), 15 minutes under argon with 40 W mercury halogen lamp, 5 minutes under air with 40 W mercury halogen lamp, 60 minutes under argon with 18 W 254 nm LED lamp, and 150 minutes under air with an 18 W 254 nm LED lamp according to embodiments of the present invention.

FIG. 3 shows the results of the reaction of alum with various real water samples both without (control) and with irradiation of 5 minutes under air with a 40 W mercury halogen lamp according to embodiments of the present invention.

FIG. 4 shows the results of the reaction of other sulfated coagulants both without irradiation (control) and under the optimal irradiation time with synthetic jar test water according to embodiments of the present invention.

FIG. 5 shows a graph of the wavelength versus percent (%) removal over a control sample according to embodiments of the present invention.

FIG. 6 shows a UV/Vis graph of an alum sample (control), an alum sample irradiated with a 254 nm light source for 120 minutes, and an alum sample irradiated with a 365 nm light source for 120 minutes according to embodiments of the present invention.

FIG. 7 shows a graph of the percent (%) removal over a control sample at various flow rates according to embodiments of the present invention.

FIG. 8 shows a graph of the percent (%) removal turbidity of active versus a control sample according to embodiments of the present invention.

FIG. 9 shows a graph of the percent (%) removal TOC of active versus a control sample according to embodiments of the present invention.

FIG. 10 shows a graph of the residual pH of a filtered jar test solution of active versus a control sample according to embodiments of the present invention.

FIG. 11 shows a graph of the percent (%) removal turbidity of active versus a control sample according to embodiments of the present invention.

FIG. 12 shows a graph of the percent (%) removal TOC of active versus a control sample according to embodiments of the present invention.

FIG. 13 shows a graph of the residual pH of a filtered jar test solution of active versus a control sample according to embodiments of the present invention.

FIG. 14 shows a graph of the percent (%) turbidity removal for alum with various free acid percentages according to embodiments of the present invention.

FIG. 15 is a schematic drawing showing a trial run set up according to embodiments of the present invention.

### DETAILED DESCRIPTION OF EMBODIMENTS

Definitions. As used in this description and the accompanying claims, the following terms shall have the meaning indicated, unless the context otherwise requires:

Turbidity refers to the cloudiness or haziness of a solution. Turbidity is measured using a nephelometer that measures the light that passes through a specific width of solution. The unit used to measure turbidity is the Nephelometric Turbidity Unit (NTU) or Formazin Nephelometric Unit (FNU). Many standards define clear as being less than 50 NFUs or NTUs. Less than 10 FNUs or NTUs may be considered crystal clear.

Total Organic Carbon (TOC) refers to total carbon containing substances within solution, that are specifically not inorganic carbons such as carbonates and bicarbonates. Also known as non-purgeable organic carbon (NPOC). TOC and NPOC are typically measured in parts per million or ppm.

Alum as used herein refers to aluminum sulfate, which has the chemical formula Al₂(SO₄)₃.

Alum solution refers to a 48 wt % aqueous solution of aluminum sulfate.

RO water refers to deionized water prepared by reverse osmosis or other membrane filtration processes.

Tap water refers to municipally treated raw water.

Ferric Sulfate solution refers to a 50 wt % solution containing ferric sulfate and RO water. In some embodiments, the ferric sulfate may be dissolved with additional sulfuric acid to lower the pH.

DelPac 2000 solution refers to a solution of polyaluminum chlorosulfate containing about 10.5 wt % aluminum oxide with about 2.7 wt % sulfate.

AlcoPASS 1000 solution refers to a solution of polyaluminum sulfate containing about 8.57 wt % Al₂O₃ and about 16.8-17.2 wt % SO₄, which is about 51% basic.

Percent (%) removal is calculated using the following equation (1):

$$\frac{{t}_{i} - {t}_{f}}{{t}_{i}} \times 100 \qquad ( 1 )$$

Where tᵢ is the initial measurement (such as turbidity or TOC), and t_{f} is the final measurement.

Photoactivation Dosage refers to the amount of light dose from the photoreactor into a liquid to be treated, not the dose into the jar test or into a water treatment facility. Photoactivation Dosage is calculated by multiplying the energy produced by a photoreactor in mW/cm² by the time of flight in seconds and the area of the light source in cm². This generates a photoactivation dosage in Joules.

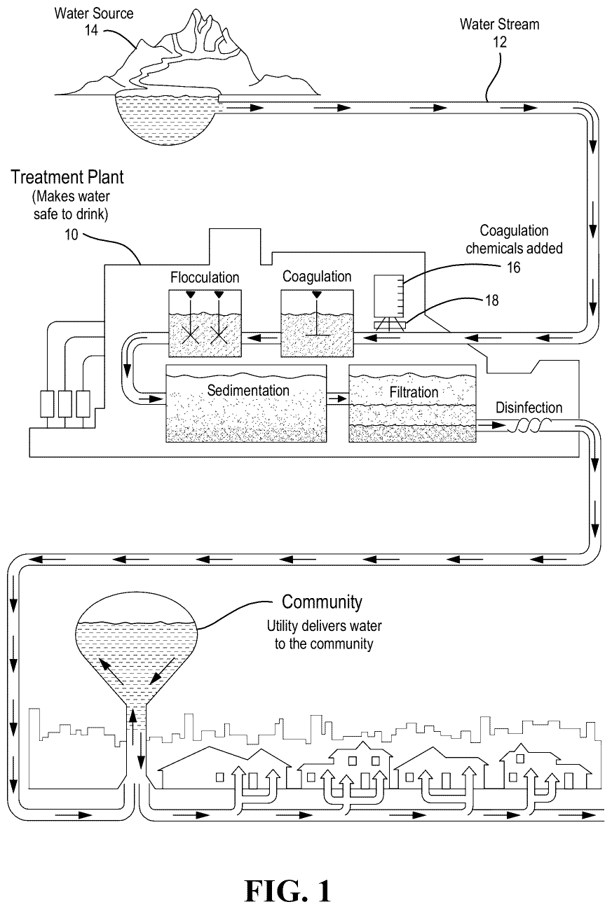

Embodiments of the present invention provide a system and process for activation of sulfated coagulants, such as aluminum sulfate and sulfated polyaluminum chlorides, using a photochemical process prior to injection of the sulfated coagulates into the water treatment system. As shown in FIG. 1, a water treatment system 10 includes a water stream 12 configured to provide raw water that needs to be treated. The raw water is provided from any water source 14. The water treatment system 10 further includes a coagulant source 16 configured to hold one or more sulfated coagulants. The sulfated coagulants may be any suitable sulfated coagulant, such as aluminum sulfate, ferric sulfate, polyaluminum chlorosulfate, polyaluminum sulfate, and/or ferrous sulfate, among others known to one skilled in the art. The water treatment system 10 further includes one or more photoreactors 18 configured to activate the one or more sulfated coagulants to produce an activated sulfated coagulant. The one or more photoreactors 18 may include a coagulant controller (not shown) configured to add the activated sulfated coagulant to the water stream 12 within a determined period. For example, the determined period may be within about 3 to 5 seconds, although longer times may be used.

The one or more photoreactors 18 may be configured to activate the one or more sulfated coagulants using one or more light sources having wavelengths ranging between about 185 nm to about 600 nm, preferably ranging between about 185 nm to about 300 nm, and more preferably ranging between about 185 nm to about 254 nm. For example, the one or more light sources may be a mercury halogen lamp, an LED light, a fluorescent lamp, and/or a neon lamp. The one or more light sources may be configured to irradiate the one or more sulfated coagulants for discreet periods of time, e.g., from about 3 seconds to about 150 minutes. For example, the one or more light sources may be a mercury halogen lamp configured to irradiate the one or more sulfated coagulants for about 3 seconds to about 15 minutes or the one or more light sources may be an LED light configured to irradiate the one or more sulfated coagulants for about 60 minutes to about 150 minutes. Alternatively, the one or more light sources may be configured to continuously irradiate the one or more sulfated coagulants. In addition, one or more light sources may be configured to irradiate the one or more sulfated coagulants for discreet periods of time, while one or more other light sources are configured to continuously irradiate the one or more sulfated coagulants. When high flow rates are used through one or more photoreactors 18, the one or more light sources may be configured to irradiate the one or more sulfated coagulants with an overall exposure time, e.g., preferably for about 3 to 5 seconds, or longer. The water treatment system 10 may further include a gas source (not shown) configured to purge the one or more sulfated coagulants with an inert gas before the one or more photoreactors 18 are configured to activate the one or more sulfated coagulants. The inert gas may be provided to the coagulant source 16 configured to hold the sulfated coagulants and/or to a coagulant outlet stream configured to provide the sulfated coagulants to the raw water.

After the one or more sulfated coagulants are activated, the activated sulfated coagulants are added to the raw water to be treated, e.g., in a rapid mix container. Injection of the one or more activated sulfated coagulants into the rapid mix container is preferably done below the surface of the liquid in the container. The potential reaction mechanisms are shown in equations (2)-(6) or (7)-(9) below. As shown in these equations, the radical is quenched by oxygen present in air, therefore the injection of the coagulant is preferably made subsurface to minimize air contamination.

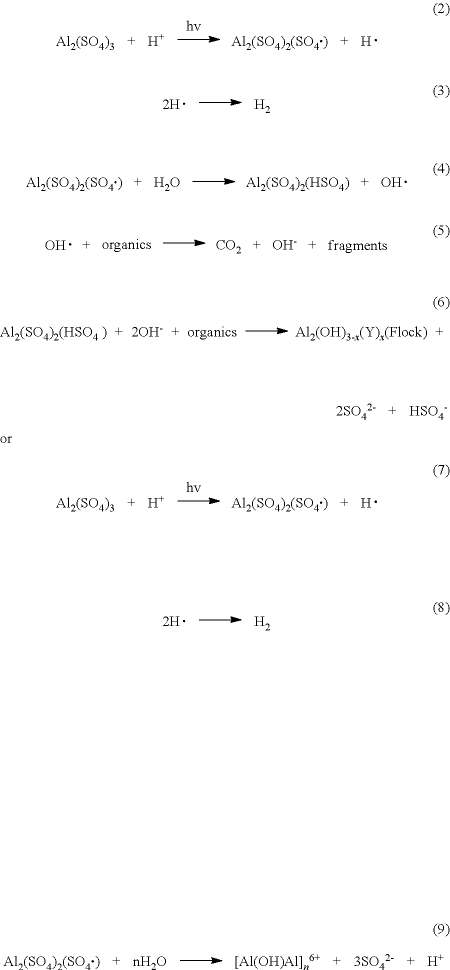

Additionally in the presence of air:

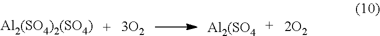

Equations (2)-(9) show the potential reaction mechanisms of photo activation of aluminum sulfate, where Y is some organic fragments, x is the remaining stoichiometric combinations, and n denotes the repeating fragment of a polymeric substance.

The UV transmissibility of aluminum sulfate is 22%. Therefore, when using aluminum sulfate as the coagulant in embodiments of the present invention, the distance from the light source to the alum coagulant is preferably about 1 cm or less. Other coagulants may have other preferable distances from the light source.

In embodiments of the present invention, the optimal contact time in the photoreactor is preferably about 3 seconds or more. When the contact time increases, the photoactivation dosage also increases, which in turn increases the efficacy of the coagulant.

Preferably, the photoreactor should be regularly cleaned. The cleaning can be done by any known process, such as disassembling the photoreactor and cleaning the various parts or by passing any commercially known cleaning agents through the photoreactor. To reduce the amount of cleaning, a filter, such as a carbon filter, may be employed in the one or more photoreactors 18 or the coagulant may pass through a filter before passing into the one or more photoreactors 18. When the coagulant passes through a filter before passing into the one or more photoreactors 18, the liquid flow process may entail alum flowing into a filter, then flowing into the one or more photoreactors 18, then injected into the raw water to be treated, such as injected into a rapid mix container. Additional efficacy may be observed from free acid where free acid is defined as between 0% and 9% free acid.

Because of the problems with PFAS compounds and other radical scavengers, such as TOC, embodiments of the present invention sought to utilize UV light to generate sulfate radicals to improve the water purification process, such as TOC reduction. Embodiments of the present invention provide for better removal of TOC and turbidity at lower coagulant doses, which translate to smaller pH depression in coagulated water, less coagulant sludge formation, and lower residual aluminum and iron. The photochemical process may be provided by one or more photoreactors 18 that can be deployed at the water treatment plant in the coagulant feed just prior to addition of the coagulant to the raw water. Embodiments enable the charge to be still intact at the time of addition to the raw water.

Photochemical synthesis of sulfate radicals provides a viable solution for the treatment of both drinking and wastewater sources. In the past, this was sometimes done by irradiating the raw water itself that contained sulfates or sulfites, e.g., sulfur dioxide, sodium sulfite, and/or persulfate sources, during the water treatment processes. Embodiments of the present invention, however, provide a method of generating sulfate radicals in the sulfated coagulants, that are then stabilized by a metal substrate with the use of various light sources, before the coagulants are added to the raw water. When applied to water treatment, these sulfate radicals can result in turbidity drops of up to about 89% and TOC drops of up to about 51% on synthetic water supplies and can result in turbidity drops of up to about 95% and TOC drops of up to about 65% on raw water supplies. Testing of other sulfated coagulants shows still improved efficacy.

The improvement may be caused by sulfate radicals reacting in a way similar to that of sulfite radicals and aluminum stabilizing the sulfate radicals for a period prior to the water treatment process. Irradiation of alum or other sulfated coagulants may result in the formation of sulfate radicals. However, due to the short half-life, stabilization of the sulfate radical is needed in embodiments of the present invention to make this process industrially relevant. Due to the operating pH of these sulfated coagulants, the principal ligand may be bisulfate, which is a non-innocent ligand in vanadium complexes. Therefore, sulfates and bisulfates may be radicalized, and coordination to a metal may help stabilize the radical long enough to allow for its practical use in water treatment systems. Embodiments of the present invention allow the time from irradiation to treatment to be increased from the us range to the seconds range. The irradiation of sulfated coagulants prior to introduction into the water treatment process is believed to generate a sulfate radical, which results in significantly increased efficacy of these sulfated coagulants.

### EXAMPLES

The following Examples describe the procedures used and tests performed on various samples to demonstrate the effectiveness of embodiments of the present invention. Examples 1-7 describe jar tests performed on sulfated coagulants, compared to control samples, using various parameters according to embodiments of the present invention. Examples 8-18 describe reproducibility tests performed on the activated coagulants at a determined optimum irradiation time. Examples 19-24 describe tests performed on sulfated coagulants using a photoreactor with various parameters according to embodiments of the present invention. Examples 19 and 23 used a Lucent360™ photoreactor by HepatoChem Inc. of Beverly, MA. Examples 20-22 and 24 used a NeoTech T222™ UV photoreactor by NeoTech Aqua Solutions, Inc. of San Diego, CA.

The solutions were placed in a photoreactor. In cases where the solution is under argon or any other inert gas (i.e. N₂), the solution was purged for a minimum of 45 minutes and kept under a constant stream of the inert gas. In the cases of under air, all samples were not purged and used as is. In some cases, the solution was irradiated with a 40 W halogen lamp and in others it was irradiated with an 18 W 254 nm light. In all cases, the optimal reaction times were determined (Examples 1-7). In all cases, the sample was removed from the reaction vessel, put on a dosing disc and put into a jar test. This whole process was completed in less than 5 seconds.

Unless otherwise specified, the jar test water was 1.0 L of a 5-gallon solution containing 0.250 g of humic acid and 0.250 g of kaolin clay dispersed in tap water. In all cases, optimization tests were performed prior to testing runs. In a given experiment, the coagulant in question was irradiated with the determined light source (as given in each specific example), under the given atmosphere. Then at specific time marks, an aliquot, as determined by previous jar testing to be an inefficient treatment, was removed, placed on a dosing disc, and a jar test was performed. Unless otherwise specified, the jar test performed had the following parameters: the solution was stirred at 100 rpm for 1 minute, and then stirred at 20 rpm for 10 minutes, and the solution was allowed to stand for 10 minutes. Post jar testing the treated water was checked for turbidity, and in the cases of optimized reaction parameters, TOC testing was done on the water sample. In the case of turbidity, a HACH TU5200 laser turbidmeter was used using a three-point calibration curve. Calibration was proven to be sufficient by testing a 10 NTU standard and RO water which theoretically should approach 0 NTU. In a given turbidity experiment, the sample vial was washed three times with the post jar test water prior to loading the sample for final turbidity measurements. In a given TOC experiment, the sample was filtered through a 47 mm, 0.45 um filter. The filter was activated by dispensing 100 mL of the sample through the filter, discarding the 100 mL of the sample, and then collecting the next 300 mL of the sample, which went through the filter. This 300 mL of the sample was then used to wash the TOC collection vial twice and fill it with the sample for testing. TOC testing was done using the operating procedure as determined by Shimadzu TOC-V ws. In all cases, before and after measurements were performed to determine the percentage of removal of TOC and turbidity to determine the efficacy. In Examples 1-18, the ACE photoreactor setup was used as the photochemical reactor (ACE glass parts 7864-10, 7874-38 and 7506-14). In cases where an 18 W LED is used, the part number is (GPH212T5L/HO) affixed with a ballast, and in any cases where 40 W mercury halogen is used, the ACE glass part number is 7825-34. The LED light source emitted 254 nm light. In Examples 19 and 23, a Lucent360™ photoreactor by HepatoChem Inc. of Beverly, MA was used. In Examples 20-22 and 24, a NeoTech T222™ UV photoreactor by NeoTech Aqua Solutions, Inc. of San Diego, CA was used. In all cases, the residual aluminum of irradiated samples was not detected via morin complexation and UV/vis measurement. All UV/vis measurements were completed using a Cary 60 UV/vis spectrometer.

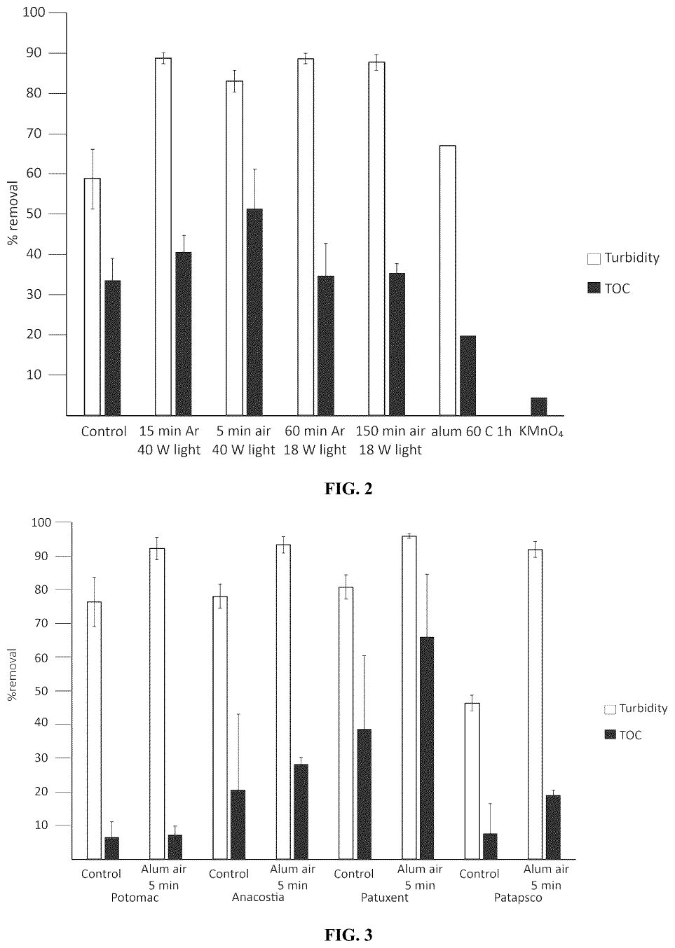

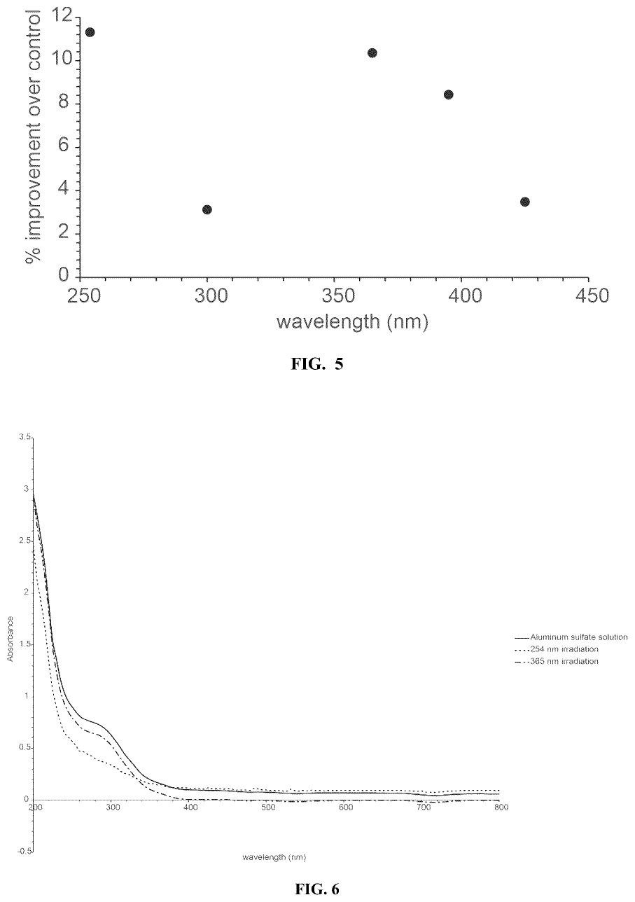

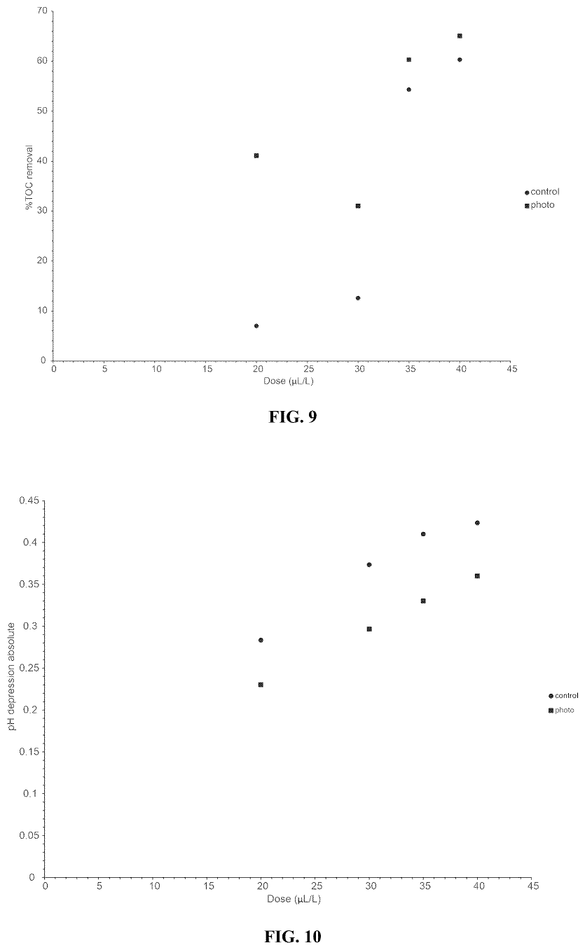

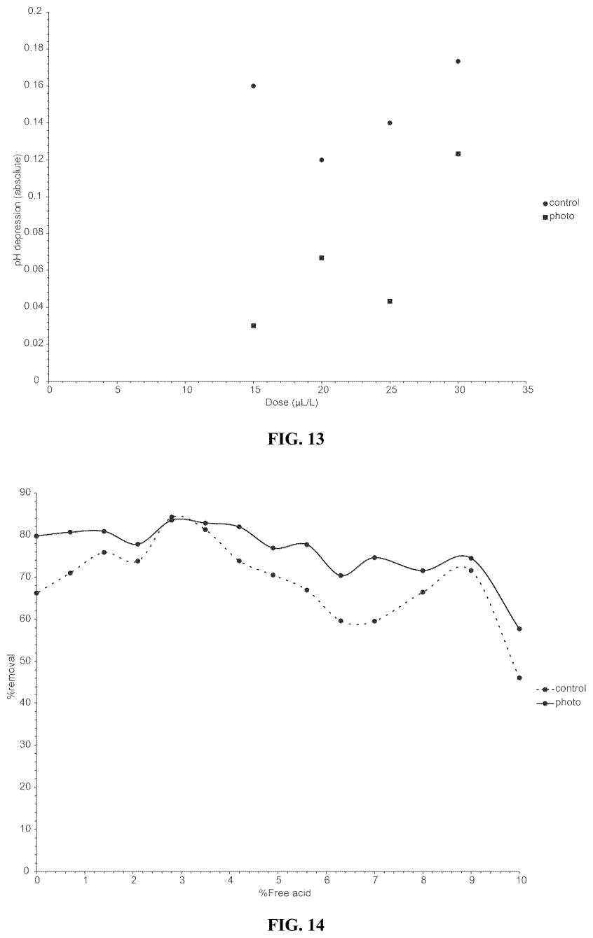

For Examples 8-18, a jar test was done as described above, a residual turbidity and TOC were then determined. Additionally, all controls were run in triplicate as well. For example, if a 50 μL dose of alum was added post irradiation, a control of 50 μL dose without irradiation was done to compare the results. To account for the fact that the UV lamps were heating the alum solution, a test of alum at 60° C. for one hour was conducted. The results are further summarized in FIGS. 2-4. Finally, all results are compared to potassium permanganate at its maximum dosage as this is a common TOC removal substance. FIGS. 5-14 show the results obtained in Examples 19-24.

### Example 1

Alum was placed in the ACE photoreactor setup and purged with argon gas for one hour. The light source used was the 40 W light source. The solution was kept under an argon atmosphere while irradiated. A 50 μL dose was taken at time points of 5, 10, 15, and 30 minutes and immediately jar tested. In almost all cases, the jar test occurred within 5 seconds of removal from the photoreactor. In this case, the optimal reaction time was determined to be approximately 15 minutes prior to jar testing. This showed a turbidity removal of 86%. This was compared with the control giving a turbidity removal of 56%.

### Example 2

Alum was placed in the ACE photoreactor setup without purging the atmosphere. The light source used was the 40 W light source. A 50 μL dose was taken at time points of 5, 10, 15, and 30 minutes and immediately jar tested. In almost all cases, the jar test occurred within 5 seconds of removal from the photoreactor. In this case, the optimal reaction time was determined to be approximately 5 minutes prior to jar testing. This showed a turbidity removal of 85%. This was compared with the control giving a turbidity removal of 56%.

### Example 3

Alum was placed in the ACE photoreactor setup and purged with argon gas for one hour. The light source used was the 18 W LED light. The solution was kept under an argon atmosphere while irradiated. A 50 μL dose was taken at time points of 5, 10, 15, 30, 60, 90, 120 and 150 minutes and immediately jar tested. In almost all cases, the jar test occurred within 5 seconds of removal from the photoreactor. In this case, the optimal reaction time was determined to be approximately 60 minutes prior to jar testing. This showed a turbidity removal of 88%. This was compared with the control giving a turbidity removal of 56%.

### Example 4

Alum was placed in the ACE photoreactor setup without purging the atmosphere. The light source used was the 18 W LED light source. A 50 μL dose was taken at time points of 5, 10, 15, 30, 60, 90, 120 and 150 minutes and immediately jar tested. In almost all cases, the jar test occurred within 5 seconds of removal from the photoreactor. In this case, the optimal reaction time was determined to be approximately 150 minutes prior to jar testing. This showed a turbidity removal of 85%. This was compared with the control giving a turbidity removal of 56%.

### Example 5

Ferric Sulfate (50 wt % in water) solution was placed in the ACE photoreactor setup without purging the atmosphere. The light source used was the 40 W light source. A 20 μL dose was taken at time points of 3, 5, and 10 minutes and immediately jar tested. In almost all cases, the jar test occurred within 5 seconds of removal from the photoreactor. In this case, the optimal reaction time was determined to be approximately 3 minutes prior to jar testing. This showed a turbidity removal of 89%. This was compared with the control giving a turbidity removal of 79%.

### Example 6

DelPac 2000, a sulfated polyaluminum chloride commercially available from USALCO of Baltimore, MD, was placed in the ACE photoreactor setup without purging the atmosphere. The light source used was the 40 W light source. A 7.5 μL dose was taken at time points of 3, 5, and 10 minutes and immediately jar tested. In almost all cases, the jar test occurred within 5 seconds of removal from the photoreactor. In this case, the optimal reaction time was determined to be approximately 3 minutes prior to jar testing. This showed a turbidity removal of 86%. This was compared with the control giving a turbidity removal of 74%.

### Example 7

AlcoPASS 1000, a polyaluminum sulfate commercially available from USALCO of Baltimore, MD, was placed in the ACE photoreactor setup without purging the atmosphere. The light source used was the 40 W light source. A 20 μL dose was taken at time points of 3, 5, and 10 minutes and immediately jar tested. In almost all cases, the jar test occurred within 5 seconds of removal from the photoreactor. In this case, a “hold time” of 40 minutes was instituted as floc was having difficulty settling at the 10-minute time frame. In this case, the optimal reaction time was determined to be approximately 5 minutes prior to jar testing. This showed a turbidity removal of 87%. This was compared with the control giving a turbidity removal of 80%.

### Example 8

Alum was placed under the same conditions listed as Example 1. Instead of sampling at points in time, the solution was irradiated for 15 minutes and 50 μL of alum was removed and dosed into the jar test solution. This resulted in a turbidity drop of 88.7±1.4% and TOC drop of 40.5±4.2%. This is in comparison to the control which saw a turbidity drop of 58.7±7.5% and TOC drop of 33.5±5.5%. In all cases, the starting turbidity approached 14±2 and the starting TOC was 12±1. This result is shown in FIG. 2.

### Example 9

Alum was placed under the same conditions listed as Example 2. Instead of sampling at points in time, the solution was irradiated for 5 minutes and 50 μL of alum was removed and dosed into the jar test solution. This resulted in a turbidity drop of 83.0±2.6% and TOC drop of 51.3±9.8%. The increased TOC drop is attributed to potentially the formation of ozone during irradiation. This is in comparison to the control which saw a turbidity drop of 58.7±7.5% and TOC drop of 33.5±5.5%. In all cases, the starting turbidity approached 14±2 and the starting TOC was 12±1. This result is shown in FIG. 2.

### Example 10

Alum was placed under the same conditions listed as Example 3. Instead of sampling at points in time, the solution was irradiated for 60 minutes and 50 μL of alum was removed and dosed into the jar test solution. This resulted in a turbidity drop of 88.6±1.3% and TOC drop of 34.7±8.0%. This is in comparison to the control which saw a turbidity drop of 58.7±7.5% and TOC drop of 33.5±5.5%. In all cases, the starting turbidity approached 14±2 and the starting TOC was 12±1. This result is shown in FIG. 2.

### Example 11

Alum was placed under the same conditions listed as Example 4. Instead of sampling at points in time, the solution was irradiated for 150 minutes and 50 μL of alum was removed and dosed into the jar test solution. This resulted in a turbidity drop of 87.7±2.0% and TOC drop of 35.4±2.3%. This is in comparison to the control which saw a turbidity drop of 58.7±7.5% and TOC drop of 33.5±5.5%. In all cases, the starting turbidity approached 14±2 and the starting TOC was 12±1. This result is shown in FIG. 2.

### Example 12

The raw water was collected from the Potomac River outside of Langley, VA after a large rain event. Alum was placed under the same conditions listed as Example 2. Instead of sampling at points in time, the solution was irradiated for 5 minutes and 5 μL of alum was removed and dosed into the jar test solution. This resulted in a turbidity drop of 92.3±3.3% and TOC drop of 7.3±2.7%. This is in comparison to the control which saw a turbidity drop of 76.4±7.3% and TOC drop of 6.6±4.7%. In all cases, the starting turbidity approached 6±2 and the starting TOC was 14±0.5. This result is shown in FIG. 3.

### Example 13

The raw water was collected from the Anacostia River at the Anacostia River National Park, after a large rain event. Alum was placed under the same conditions listed as Example 2. Instead of sampling at points in time, the solution was irradiated for 5 minutes and 25 μL of alum was removed and dosed into the jar test solution. This resulted in a turbidity drop of 93.3±2.4% and TOC drop of 28.2±2.0%. This is in comparison to the control which saw a turbidity drop of 78.1±3.6% and TOC drop of 20.6±22.3%. In all cases, the starting turbidity approached 24±3 and the starting TOC was 15±1. This result is shown in FIG. 3.

### Example 14

The raw water was collected from the Patuxent River near Riverfront Park, after a large rain event. Alum was placed under the same conditions listed as Example 2. Instead of sampling at points in time, the solution was irradiated for 5 minutes and 20 μL of alum was removed and dosed into the jar test solution. This resulted in a turbidity drop of 95.9±0.7% and TOC drop of 65.9±18.6%. This is in comparison to the control which saw a turbidity drop of 80.8±3.6% and TOC drop of 38.7±21.8%. In all cases, the starting turbidity approached 35±1 and the starting TOC was 6±1. This result is shown in FIG. 3.

### Example 15

The raw water was collected from the Patapsco River near Hilltop Road, after a large rain event. Alum was placed under the same conditions listed as Example 2. Instead of sampling at points in time, the solution was irradiated for 5 minutes and 15 μL of alum was removed and dosed into the jar test solution. This resulted in a turbidity drop of 91.9±2.3% and TOC drop of 19.0±1.6%. This is in comparison to the control which saw a turbidity drop of 46.4±2.4% and TOC drop of 7.7±8.7%. In all cases, the starting turbidity approached 3±0.5 and the starting TOC was 10±1. This result is shown in FIG. 3.

### Example 16

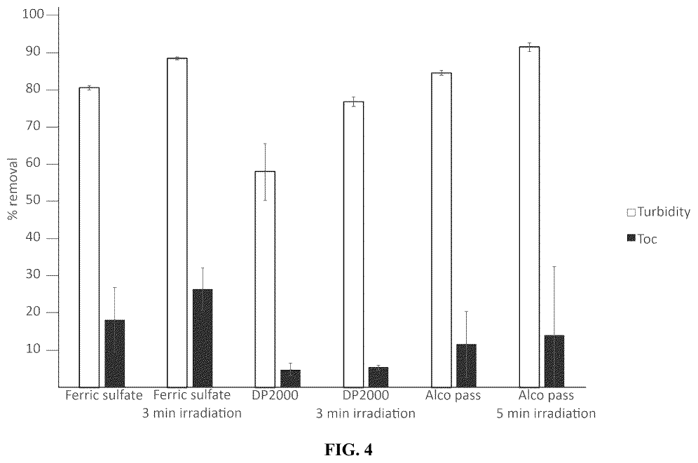

Ferric sulfate solution was placed under the same conditions listed as Example 5. Instead of sampling at points in time, the solution was irradiated for 3 minutes and 20 μL of ferric sulfate solution was removed and dosed into the jar test solution. This resulted in a turbidity drop of 88.5±0.47% and TOC drop of 26.3±5.8%. This is in comparison to the control which saw a turbidity drop of 80.6±0.64% and TOC drop of 18.0±8.6%. In all cases, the starting turbidity approached 14±2 and the starting TOC was 12±1. This result is shown in FIG. 4.

### Example 17

DelPac 2000 solution, a sulfated polyaluminum chloride commercially available from USALCO of Baltimore, MD, was placed under the same conditions listed as Example 6. Instead of sampling at points in time, the solution was irradiated for 3 minutes and 7.5 μL of DelPac 2000 solution was removed and dosed into the jar test solution. This resulted in a turbidity drop of 76.7±1.3% and TOC drop of 5.4±0.8%. This is in comparison to the control which saw a turbidity drop of 58.0±7.7% and TOC drop of 4.8±1.6%. In all cases, the starting turbidity approached 14±2 and the starting TOC was 12±1. This result is shown in FIG. 4.

### Example 18

AlcoPASS 1000 solution, a polyaluminum sulfate commercially available from USALCO of Baltimore, MD, was placed under the same conditions listed as Example 7. Instead of sampling at points in time, the solution was irradiated for 5 minutes and 20 μL of AlcoPASS 1000 solution was removed and dosed into the jar test solution. In all cases, the solution was allowed to rest for 40 minutes to quell floc suspension issues. This resulted in a turbidity drop of 91.4±1.2% and TOC drop of 13.9±18%. This is in comparison to the control which saw a turbidity drop of 84.6±0.64% and TOC drop of 11.5±8.8%. In all cases, the starting turbidity approached 14±2 and the starting TOC was 12±1. This result is shown in FIG. 4.

### Example 19

A low-pressure mercury halogen lamp emits light at various wavelengths at once. To isolate the wavelengths used in this Example, a Lucent360™ photoreactor was purchased from HepatoChem Inc. of Beverly, MA. In this Example, an LED light source having wavelengths at 254 nm, 300 nm, 365 nm, 395 nm, and 425 nm was used. A 3 mL sample of alum was placed in a quartz cuvette purchased from Sigma Aldrich of Saint Louis, MO. This sample was then irradiated at the specified wavelength over a period of time up to 120 minutes with samples removed every 15 minutes. A 20 μL aliquot was removed and used as the coagulant with the synthetic jar test solution within 5 seconds. The resulting data is shown in FIG. 5. In all circumstances, the % turbidity removal compared to a control was determined for efficacy. This was calculated by % Turbidity removal (active species)−% Turbidity removal (control).

As shown in FIG. 5, 254 nm was the best wavelength for exciting aluminum sulfate when wavelengths ranging from 254 nm-425 nm were used. However, a steep drop off at 300 nm was observed, and then at 365 nm there was similar efficacy as the 254 nm irradiated sample. To confirm that the 365 nm wavelength did not excite the aluminum sulfate, the solution was placed under an Ar atmosphere and irradiated with a 254 nm light source for 30 minutes. The resulting UV/vis graph is shown in FIG. 6. As shown in FIG. 6, the peak at around 280-300 nm was gone with the 254 nm irradiated sample, but still existed with the 365 nm irradiated sample. This indicates that something else was occurring with the 365 nm irradiated sample.

The alum sample irradiated with a 254 nm light source for a reaction time of 120 minutes was observed to have a temperature change of 3.8° C. (from 21.5° C. to 25.3° C.). The alum sample irradiated with a 365 nm light source for a reaction time of 120 minutes was observed to have a temperature change of 46.3° C. (from 22.5° C. to 68.8° C.). Alum is known to have better efficacy on a hot day, and that is likely what was observed at the higher wavelengths. The higher nm wavelength light sources were generating significant heat, which was then increasing the efficacy of the coagulant, whereas the sample irradiated with a 254 nm light source was likely chemically transformed, giving increased efficacy to the coagulant.

Finally, a 185/254 nm light source was purchased from Sigma Aldrich of Saint Louis, MO, and used in an immersion well. This Example resulted in a 23% improvement over the control sample after 15 minutes of irradiation time and the sample had only a 2° C. change in the temperature of the solution. Therefore, the optimal light source for embodiments of the present invention was found to be a 185/254 nm combination when an aluminum sulfate coagulant was used.

### Example 20

To examine the efficacy of embodiments of the present invention as an inline product, a NeoTech T222™ UV photoreactor from NeoTech Aqua Solutions, Inc. of San Diego, CA was procured. The void volume on the photoreactor was approximately 466 mL. The inner quartz sleeve contains a low-pressure mercury halogen lamp that is capable of emitting 185/254 nm light combination. The photoreactor also contained a sensor that read the efficacy of the light as a power reading in mW/cm². The photoreactor can be used to calculate a photoactivation dosage for the system by multiplying the flight time and length of the tube in the photoreactor. This photoactivation dosage differs from the dosage that is commonly used in water treatment facilities which refers to the amount of coagulant added to the water to be treated.

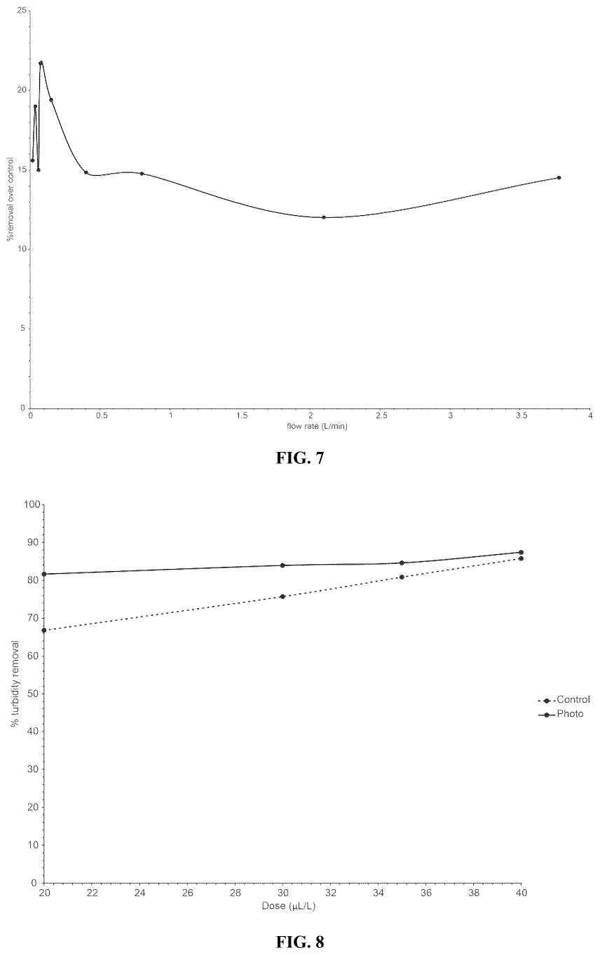

The initial experiments examined the effect of flow rate on the efficacy of the coagulant reaction. To examine this effect, aluminum sulfate was recycled through the photoreactor at the desired flow rates for at least 30 minutes. This experiment was conducted to ensure that there were no leaks within the photoreactor setup and to ensure that the photoreactor is “flooded” with alum. An inline sampling point was placed on the photoreactor so Jar Testing could occur with “active” species. After flooding and leak testing, the outlet tube was placed into a 55-gallon drum, and the photoreactor was switched from off to on. The photoreactor was allowed to run 45 minutes prior to sampling to ensure that the reaction was in a “steady-state” environment. After 45 minutes, a 20 μL sample was removed and placed in the Jar Test solution. A summary of these results is shown in FIG. 7.

As shown in FIG. 7, the efficacy of the photoreactor decreases at the faster flow rates when aluminum sulfate was used as the coagulant, where the drop off appears approximately at 0.15 L/min and continues until 1.89 L/min. At 1.89 L/min, the time of flight based upon a void volume of 466 mL equates to a resonance time of about 3 seconds. This indicates that flight times of less than 3 seconds for aluminum sulfate as the coagulant would result in significantly less effective coagulant.

### Example 21

In this example, the flow rate was set to 0.4 L/min with no filtration. A synthetic Jar Test solution was used as the target water. To examine this effect, aluminum sulfate was recycled through the photoreactor at the desired flow rates for at least 30 minutes. This experiment was conducted to ensure that there were no leaks within the photoreactor setup and to ensure that the photoreactor was “flooded” with alum. An inline sampling point was placed on the photoreactor so Jar Testing could occur with “active” species. After flooding and leak testing, the outlet tube was placed into a 55-gallon drum, and the photoreactor was switched from off to on. The photoreactor was allowed to run 45 minutes prior to sampling to ensure that the reaction was in a “steady-state” environment. After 45 minutes, the requisite sample volume was removed and placed in the Jar Test solution. A summary of these results is shown in FIGS. 8-10. The residual pH was done using a pH probe calibrated on a 3 point calibration curve.

After a period of time, buildup within the photoreactor occurred so regular cleaning was employed. The extent of the buildup was less when a carbon and size exclusion filter was used. The carbon filter could be used either in line or from the batch of aluminum sulfate. Cleaning of the photoreactor occurred using commercial cleaning agents, such as Alconox® manufactured by Alconox, Inc. of White Plains, NY or Hellmenex® manufactured by Hellma USA Inc. of Plainview, NY, then rinsing with alcohol, and then water. Other commercial cleaning agents such as citric acid or caustic solutions could be used as well.

### Example 22

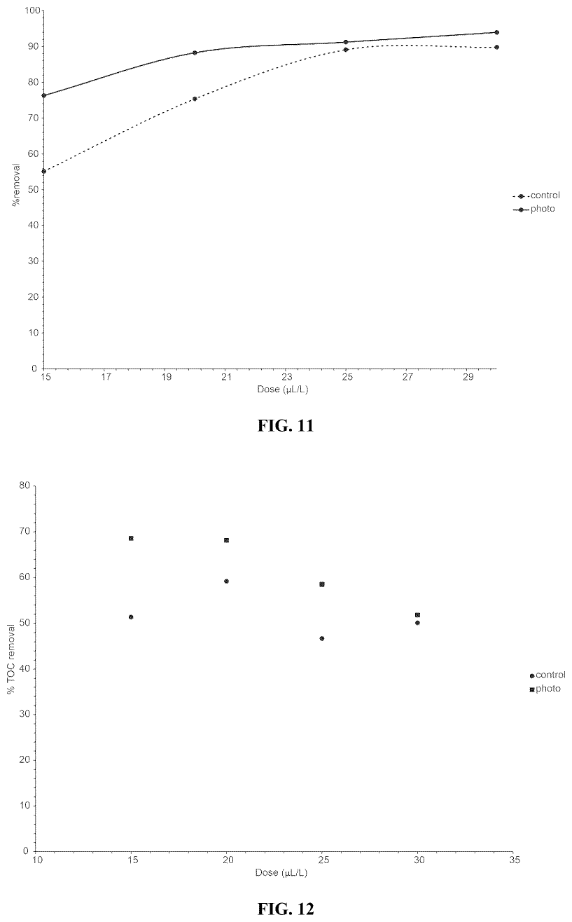

In this example, the flow rate was set to 0.4 L/min with no filtration. Water gathered from the Anacostia River was used as the target water. To examine this effect, aluminum sulfate was recycled through the photoreactor at the desired flow rates for at least 30 minutes. This experiment was conducted to ensure that there were no leaks within the photoreactor setup and to ensure that the photoreactor was “flooded” with alum. An inline sampling point was placed on the photoreactor so Jar Testing could occur with “active” species. After flooding and leak testing, the outlet tube was placed into a 55-gallon drum, and the photoreactor was switched from off to on. The photoreactor was allowed to run 45 minutes prior to sampling to ensure that the reaction was in a “steady-state” environment. After 45 minutes, the requisite sample volume was removed and placed in the Jar Test solution. A summary of these results is shown in FIGS. 11-13. The residual pH was done using a pH probe calibrated on a 3 point calibration curve.

### Example 23

To determine the effect of free acid on the effectiveness of alum and its photocoagulation, a Lucent360™ photoreactor was purchased from HepatoChem Inc. of Beverly, MA. In this Example, an LED light source having wavelengths at 254 nm was used. A 1 cm quartz cuvette was purchased from Sigma Aldrich of Saint Louis, MO and was used as the holder with approximately 3 mL of solution. Each solution was irradiated for 30 minutes. A 20 μL sample was removed and placed into the synthetic jar test solution within 5 seconds of completion. Each solution was made at various % of free acid, and their results are shown in FIG. 14. There appears to be increased efficacy of the coagulant up to 9% free acid as compared to 0% free acid as is typical of regular alum. Additionally, for this specific water species, free acid of about 2.8% was optimal for turbidity removal for regular alum. This specific value may change based on various factors such as TOC, turbidity, alkalinity, pH, and others.

### Example 24

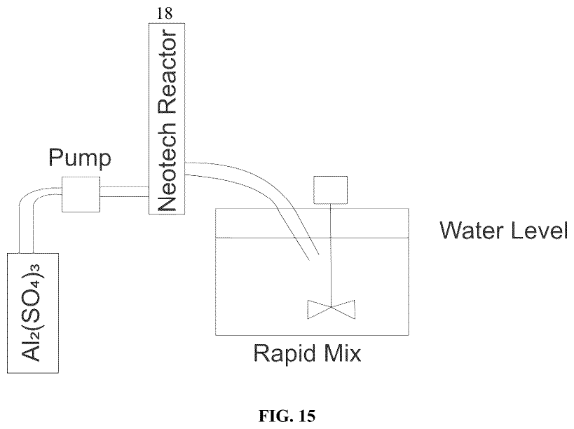

To determine the efficacy in a “real world scenario”, a trial run was conducted at LaFourche Parish water district number 1, located in Lockport, LA. LaFourche Parish gets their water from the Mississippi River, therefore the treated water was high in turbidity and moderate in TOC. This water district uses aluminum sulfate to treat their water supply, along with lime to manage their alkalinity and pH, and a polymer to help with final cleanup. Prior to installation at LaFourche Parish, the NeoTech T222™ UV photoreactor was mounted in a Pelican case that was modified with an inlet and outlet tube, along with a viewing window. The photoreactor was placed next to the rapid mix container and flow from the photoreactor to the rapid mix container occurred within about 3 seconds. A schematic drawing showing the trial run set up is shown in FIG. 15. The aluminum sulfate was put directly below the water level and as close to the rapid mix container blade as possible.

A summary of the data collected is provided in Table 1. On the evening of day 2, the photoreactor was installed, on day 3, the photoreactor ran, and on day 4, the photoreactor ran with a photoactivation dosage decrease of 10% with no other changes. The water quality did not change on day 4 compared to day 3, despite the lowering of the photoactivation dosage, indicating that the photoreactor was making the coagulant more efficient.

TABLE 1
Total turbidity measurements by day (avg).

| | | | | | | Service | |
|---|---|---|---|---|---|---|---|
| Day | Bayou | Reservoir | Basin(mid) | Basin (end) | Filter | water | Tap |
| 1 | 63 | 84 | 1.5 | 1.3 | 0.05 | 0.48 | 0.37 |
| 2 | 125 | 75 | 1.2 | 1.2 | 0.05 | 0.49 | 0.44 |
| 3 | 146 | 91 | 1.3 | 1.0 | 0.04 | 0.28 | 0.21 |
| 4 | 84 | 100 | 1.0 | 1.2 | 0.04 | 0.24 | 0.17 |

Although the above discussion discloses various exemplary embodiments, those skilled in the art may make various modifications to, or variations of, the illustrated embodiments without departing from the inventive concepts disclosed herein.

What is claimed is:

1. A water treatment system comprising:
a water stream configured to provide raw water to be treated;
a coagulant source configured to hold one or more sulfated coagulants; and
one or more photoreactors configured to activate the one or more sulfated coagulants to produce an activated sulfated coagulant and configured to add the activated sulfated coagulant to the water stream within a determined period.

2. The water treatment system of claim 1, wherein the one or more sulfated coagulants include aluminum sulfate, ferric sulfate, polyaluminum chlorosulfate, polyaluminum sulfate, ferrous sulfate or combinations thereof.

3. The water treatment system of claim 1, wherein the one or more photoreactors include a coagulant controller configured to add the activated sulfated coagulant to the water stream within about 3 to 5 seconds from activating the one or more sulfated coagulants.

4. The water treatment system of claim 1, wherein the one or more photoreactors are configured to activate the one or more sulfated coagulants using one or more light sources having wavelengths ranging between about 185 nm to about 300 nm.

5. The water treatment system of claim 4, wherein the one or more light sources are configured to irradiate the one or more sulfated coagulants for about 3 seconds to about 150 minutes.

6. The water treatment system of claim 4, wherein the one or more light sources are configured to continuously irradiate the one or more sulfated coagulants.

7. The water treatment system of claim 4, wherein the one or more light sources include a mercury halogen lamp, an LED light, a fluorescent lamp, a neon lamp or combinations thereof.

8. The water treatment system of claim 7, wherein the one or more light sources include a mercury halogen lamp and are configured to irradiate the one or more sulfated coagulants for about 3 seconds to about 15 minutes.

9. The water treatment system of claim 7, wherein the one or more light sources include an LED light and are configured to irradiate the one or more sulfated coagulants for about 60 minutes to about 150 minutes.

10. The water treatment system of claim 1, further comprising a gas source configured to purge the one or more sulfated coagulants with an inert gas before the one or more photoreactors are configured to activate the one or more sulfated coagulants.

11. A method of water treatment, the method comprising:
providing one or more sulfated coagulants;
activating the one or more sulfated coagulants using a photochemical process to produce an activated sulfated coagulant; and
adding the activated sulfated coagulant into raw water within a determined period.

12. The method of claim 11, wherein the one or more sulfated coagulants include aluminum sulfate, ferric sulfate, polyaluminum chlorosulfate, polyaluminum sulfate, ferrous sulfate or combinations thereof.

13. The method of claim 11, wherein the determined period is within about 3 seconds to about 5 seconds of activating the one or more sulfated coagulants.

14. The method of claim 11, wherein the photochemical process includes irradiating the one or more sulfated coagulants with one or more light sources having wavelengths ranging between about 185 nm to about 300 nm.

15. The method of claim 14, wherein the one or more light sources irradiate the one or more sulfated coagulants for about 3 seconds to about 150 minutes.

16. The method of claim 14, wherein the one or more light sources continuously irradiate the one or more sulfated coagulants.

17. The method of claim 14, wherein the one or more light sources include a mercury halogen lamp, an LED light, a fluorescent lamp, a neon lamp or combinations thereof.

18. The method of claim 17, wherein the one or more light sources include a mercury halogen lamp irradiating the one or more sulfated coagulants for about 3 seconds to about 15 minutes.

19. The method of claim 17, wherein the one or more light sources include a LED light irradiating the one or more sulfated coagulants for about 60 minutes to about 150 minutes.

20. The method of claim 11, further comprising purging the one or more sulfated coagulants with an inert gas before using the photochemical process.
